(19) United States
(12) Patent Application Publication
(10) Pub. No.: US 2026/0014768 A1
(43) Pub. Date: Jan. 15, 2026

(54) ROTARY PRESS

(71) Applicant: FETTE COMPACTING GMBH, Schwarzenbek (DE)

(72) Inventors: Sven KOLBE, Buchen (DE); Andreas ARNING, Talkau (DE)

(21) Appl. No.: 19/263,258

(22) Filed: Jul. 8, 2025

(30) Foreign Application Priority Data
Jul. 9, 2024 (DE) 10 2024 119 455.3

(51) Int. Cl. B30B 15/02; B30B 3/00; B30B 11/08; B30B 15/32

(52) U.S. Cl. CPC B30B 15/022; B30B 3/00; B30B 11/08; B30B 15/32

(57) ABSTRACT

The invention relates to a rotary press comprising a rotor rotatable by means of a rotary drive, wherein the rotor has an upper punch guide for upper pressing punches and a lower punch guide for lower pressing punches as well as a die plate arranged between the punch guides, wherein the pressing punches interact with cavities of the die plate, wherein the rotary press further comprises a filling apparatus, by means of which powder material to be pressed is filled into the cavities of the die plate, and wherein the rotary press comprises a pressure apparatus with an upper pressure unit and a lower pressure unit, which, during operation, interact with the upper pressing punches and with the lower pressing punches to press the powder material in the cavities of the die plate to form pellets, and wherein the rotary press comprises a removal apparatus for removing pellets ejected onto the upper side of the die plate by the lower pressing punches after pressing, wherein the removal apparatus has a removal channel arranged at least in portions above the die plate, so that pellets ejected from the cavities onto the upper side of the die plate by the lower pressing punches are conducted along the removal channel from the die plate to a first pellet outlet.

The invention relates to a rotary press comprising a rotor rotatable by means of a rotary drive, wherein the rotor has an upper punch guide for upper pressing punches and a lower punch guide for lower pressing punches as well as a die plate arranged between the punch guides, wherein the pressing punches interact with cavities of the die plate, wherein the rotary press further comprises a filling apparatus, by means of which powder material to be pressed is filled into the cavities of the die plate, and wherein the rotary press comprises a pressure apparatus with an upper pressure unit and a lower pressure unit, which, during operation, interact with the upper pressing punches and with the lower pressing punches to press the powder material in the cavities of the die plate to form pellets, and wherein the rotary press comprises a removal apparatus for removing pellets ejected onto the upper side of the die plate by the lower pressing punches after pressing, wherein the removal apparatus has a removal channel arranged at least in portions above the die plate, so that pellets ejected from the cavities onto the upper side of the die plate by the lower pressing punches are conducted along the removal channel from the die plate to a first pellet outlet.

In rotary presses, a large number of upper and lower pressing punches are generally provided which are in each case assigned to one cavity of a die plate in pairs. During operation of the rotary press, the upper and lower pressing punches rotate together with the die plate, wherein their axial movement is controlled by means of control cams and is guided by means of upper and lower punch guides. During the course of the rotation, the die plate travels through various apparatuses of the rotary press, namely a filling apparatus, in which powder material to be pressed is guided into the cavities of the die plate, and a pressure apparatus, in which the upper and lower pressing punches are typically pressed into the cavities by means of upper and lower pressure rollers in order to press the powder material into pellets, such as tablets. Subsequent to the pressure apparatus, the upper pressing punches are guided upward out of the cavities and the pellets generated in the cavities are pushed by the lower pressing punches onto the upper side of the die plate. Such rotary presses also comprise a removal apparatus for removing the pellets ejected by the lower pressing punches onto the upper side of the die plate after the pressing process. The removal apparatuses comprise a removal channel which is arranged at least in portions above the die plate and conducts the pellets ejected onto the upper side of the die plate from the die plate, which rotates under the removal channel, to a first pellet outlet. The first pellet outlet can be, for example, an outlet for pellets that are identified as good.

In DE 10 2016 101 027 B4 and DE 10 2016 101 028 B4, in a good channel is arranged a vacuum apparatus, which adjoins a remover and extracts tablets, which are conducted by the remover in the direction of the good channel, from the die plate by means of a vacuum and conveys them away through the good channel, in order to ensure smooth transport of tablets to the first pellet outlet. In this way, tablets lying individually on the die plate can be prevented and smooth removal of the tablets can be ensured. Air curtains can also be used to stabilize the tablets on the die plate. For this purpose, a constant air flow can be directed onto the tablets, which presses them onto the die plate.

Although the vacuum apparatuses described reliably convey tablets from the good channel, as soon as the tablets are located in the good channel, under unfavorable conditions tablets may accumulate after leaving their respective cavities, in particular since the tablets are accelerated in a vertical direction by the lower pressing punches during ejection. The removal apparatuses with a vacuum apparatus also require a considerable amount of space in the rotary press, and a high flow rate and therefore a large amount of extraction air, which is expensive in particular in the pharmaceutical sector, is required for reliable extraction of the tablets.

Based on the prior art described above, the invention is therefore based on the task of providing a rotary press of the type mentioned at the outset, which enables reliable conveying of pellets to the first pellet outlet at all times in a space-saving and resource-saving manner.

The invention achieves the object with the subject matter of independent claim 1. Advantageous embodiments can be found in the dependent claims, the description, and the figures.

For a rotary press of the type mentioned at the outset, the invention achieves the object in that the portion of the removal channel arranged above the die plate has a vacuum apparatus, by means of which the pellets located on the die plate are sucked along the removal channel to the first pellet outlet.

The basic structure of a rotary press, as is the subject matter of the present invention, was explained at the outset. As explained, the upper and lower punch guides guide the pressing punches during their axial movement. The punch heads interact with control cams that move the pressing punches in the axial direction, in particular towards and away from each other, as they rotate with the rotor. The control cams are typically made up of several control cam elements. They can accommodate the punch heads in corresponding guide receptacles or rest only against a mirror surface of the punch heads. The pressure apparatus typically comprises an upper pressure roller and a lower pressure roller, which interact with the punch heads of the upper and lower pressing punches, respectively. Several pressure apparatuses of this type can also be provided, for example pre-pressure apparatuses and main pressure apparatuses. The ejector cam, as part of the control cams, moves the lower pressing punches upward after the pellets have been generated in their respective cavities, so that the pellets reach the upper side of the die plate, from where they are conveyed to the first pellet outlet via the removal channel. The pellets can in particular be tablets. Accordingly, the rotary press can be a rotary tablet press. The tablets can be pharmaceutical tablets, for example.

The removal channel can be sickle-shaped, for example. It can be arranged with a first portion above the die plate and with a second portion radially outside of the die plate. It is fixed in relation to the rotor, in particular the die plate, so that the die plate rotates under the removal channel during operation of the rotary press. The removal channel can be arranged at a small distance above the die plate. In particular, the distance is smaller than the thinnest pellet to be produced in the rotary press, so that all pellets are captured by the removal channel. As the die plate rotates, the pellets expelled onto the upper side of the die plate by the lower pressing punches after the pressing process are scraped from the die plate from the removal channel, in particular a channel wall of the removal channel, and conveyed in the direction of the first pellet outlet. As explained, the first pellet outlet can be, for example, a good outlet for pellets identified as good, for example, by the sensors of the rotary press.

According to the invention, the portion of the removal channel arranged above the die plate has a vacuum apparatus, by means of which the pellets located on the die plate are sucked along the removal channel to the first pellet outlet. According to the invention, the vacuum apparatus is thus integrated into the removal channel, and in particular into the portion of the removal channel located above the die plate. The vacuum apparatus is therefore located close to the expulsion point at which the pellets are pushed out of the cavity onto the upper side of the die plate by the lower pressing punches. The pellets are thus stabilized at a very early stage, in particular directly after leaving their respective cavities, by a gas flow, in particular an air flow, generated by the vacuum apparatus and are accelerated along the removal channel in the direction of the first pellet outlet. This ensures particularly reliable conveying of the tablets through the removal channel and reliably prevents tablet jams. At the same time, the vacuum apparatus is arranged on or integrated into the removal channel in a compact and space-saving manner. Due to the arrangement of the vacuum apparatus on the removal channel, the vacuum apparatus also has to operate over a shorter distance than if it were arranged in a good channel downstream of the removal channel, such that less compressed gas or, respectively, compressed air is required to operate the vacuum apparatus and resources are conserved.

According to one embodiment, it can be provided that the vacuum apparatus is arranged on the portion of the removal channel arranged above the die plate in such a way that an extraction effect is generated by the vacuum apparatus on pellets already during ejection from the cavities by the lower pressing punches. In this embodiment, the vacuum apparatus is arranged on the removal channel in such a way that a suction effect generated by the vacuum apparatus on pellets already occurs when they are still inside their respective cavities during the ejection process by the lower pressing punches. In this embodiment, the vertical acceleration of the pellets out of the cavities caused by the lower pressing punches is overlaid and deflected by the suction effect generated by the vacuum apparatus, thus stabilizing the movement of the pellets. This particularly reliably prevents the pellets from accumulating and overtaking each other during ejection from the cavities.

According to a further embodiment, it can be provided that the vacuum apparatus is arranged on the portion of the removal channel arranged above the die plate in such a way that an air flow generated by the vacuum apparatus flows over pellets ejected from the cavities by the lower pressing punches. The arrangement of the vacuum apparatus on the portion of the removal channel located above the die plate achieves a particularly effective flow over pellets on the die plate due to the suction effect generated by the vacuum apparatus. In addition to a suction force parallel to the floor of the die plate or, respectively, the removal channel in the direction of the first pellet outlet, such a flow also leads to a force component directed vertically upward. The combination of these forces acting on the pellets ensures that the pellets are conveyed particularly evenly and smoothly over the surface.

According to a further embodiment, the vacuum apparatus can have integrated vacuum nozzles in the portion of the outlet channel arranged above the die plate. The desired suction effect can be generated by the vacuum nozzles, preferably using the Venturi effect. The vacuum nozzles can blow out a compressed gas, for example compressed air, in the desired direction of movement of the pellets in order to generate a vacuum that conveys the pellets in this direction of movement. The vacuum nozzles create a suction effect in the direction of movement of the pellets in the direction of the first pellet outlet. This embodiment achieves particularly effective conveying of the pellets.

According to a further embodiment, it can be provided that vacuum nozzles integrated into the portion of the removal channel arranged above the die plate are arranged above and/or close to the ejection point of the pellets when they are ejected from the cavities by the lower pressing punches. By arranging the vacuum nozzles above and/or close to the ejection point of the pellets when they are ejected from the cavities, the vertical acceleration of the pellets during the ejection process is advantageously deflected and stabilized by the suction effect, as explained above. In addition, the arrangement at or near the ejection point can further reduce the amount of compressed gas required or, respectively, compressed air required compared to the prior art.

According to a further embodiment, it can be provided that the removal channel has a first channel wall guiding the pellets to the first pellet outlet and a channel ceiling covering the removal channel at least in portions, and that vacuum nozzles are arranged in the first channel wall and in the channel ceiling. The removal channel can also have a second channel wall opposite the first channel wall, wherein vacuum nozzles can also be arranged in the second channel wall. The first channel wall, the channel ceiling and the second channel wall can form a U-profile. They can be formed in one piece or from several portions. The aforementioned annular arrangement of the vacuum nozzles around the conveying space for the pellets, which is delimited by the removal channel, achieves a particularly even and effective suction effect on the pellets in the direction of movement towards the pellet outlet. Opposite the channel ceiling, the removal channel is open, in particular in the region of its portion arranged above the die plate, so that the space delimited by the removal channel is delimited on the underside by the surface of the die plate, at least in the region of the portion arranged above the die plate. A portion of the removal channel arranged radially outside the die plate, on the other hand, can have a channel floor opposite the channel ceiling to guide the pellets.

According to a further embodiment, it can be provided that the vacuum nozzles each have an elongated nozzle portion extending in the direction of conveyance of the pellets toward the first pellet outlet, and that a compressed gas, in particular compressed air, is conducted through the elongated nozzle portion by the vacuum apparatus. The elongated portion can be straight or curved. In this way, the Venturi effect, which can be used for the suction effect as explained above, is used particularly effectively.

According to a further embodiment, it can be provided that the vacuum apparatus has a compressed gas supply apparatus, in particular a compressed air supply apparatus, for supplying the vacuum nozzles with compressed gas, in particular compressed air, wherein the compressed gas supply apparatus has a supply channel leading along the removal channel from a compressed gas supply to the vacuum nozzles. The supply channel can be integrated into the removal channel. These embodiments allow a particularly compact and space-saving structure, in that the supply channel of the compressed gas supply apparatus runs parallel to the removal channel or, respectively, is integrated into it.

According to a further embodiment, it can be provided that a sorting apparatus is also provided for sorting pellets ejected from the cavities into a second pellet outlet arranged upstream of the first pellet outlet in the direction of conveyance of the pellets, wherein the sorting apparatus comprises a sorting nozzle for sorting pellets into the second pellet outlet by means of compressed gas. The sorting nozzle can also be supplied with compressed gas by the compressed gas supply, for example through the supply channel or another supply channel. If a further supply channel is provided, it can also run parallel to the removal channel or be integrated into it. The second pellet outlet, which can be, for example, a bad outlet for pellets identified as bad by the sensors of the rotary press, is located upstream of the first pellet outlet as seen in the direction of movement of the pellets. When the sorting apparatus is inactive, the pellets are conveyed past the second pellet outlet through the removal channel in the direction of the first pellet outlet. If, on the other hand, a pellet is identified as bad and should be sorted accordingly, the sorting apparatus is activated. In particular, a blast of compressed gas, in particular compressed air, is applied to the pellet transversely to its direction of movement by the sorting nozzle, so that the pellet is deflected from its path of conveyance into the second pellet outlet. While the first pellet outlet can lead, for example, to a good output for further processing of the generated pellets, the second pellet outlet can lead to a bad output for reject pellets. In the aforementioned embodiments, the compressed gas supply required anyway for sorting by means of the sorting apparatus can advantageously be used simultaneously to supply the vacuum apparatus. This further simplifies the structure and saves even more space.

According to a further embodiment, the removal channel can extend as far as the sorting apparatus. This means that the suction effect can be generated particularly close to the expulsion point where the pellets are expelled from the cavities. The additional channel length generated in this way of the removal channel generates the vacuum in the channel and thus also on the die plate. To realize a particularly compact embodiment, the sorting nozzle can be integrated into the removal channel.

According to a further embodiment, a first detector apparatus may be arranged in the first pellet outlet, said first detector apparatus detecting pellets conducted through the first pellet outlet and/or a second detector apparatus may be arranged in a second pellet outlet, said second detector apparatus detecting pellets conducted through the second pellet outlet. Pellets produced in the rotary press are guided selectively into the first pellet outlet or the second pellet outlet, in particular depending on a detection of the pellets as good or bad. As explained above, the second pellet outlet may be a bad outlet for pellets identified as bad by sensors of the rotary press. The second pellet outlet may in particular be the second pellet outlet explained above, such that it can be referred to the above explanations.

In the foregoing embodiment a first detector apparatus may be arranged in the first pellet outlet, said first detector apparatus detecting pellets conducted through the first pellet outlet. Further, a second detector apparatus may be arranged in a second pellet outlet, said second detector apparatus detecting pellets conducted through the second pellet outlet. In the prior art a detection of ejected pellets takes place in particular by monitoring the pressure build-up in nozzle arrangements used for the transport of pellets. For example, a blockage of the nozzle arrangements may lead to faulty detection results. This problem is overcome according to the foregoing embodiment. At the same time, a redundant detection of ejected pellets can be realized.

By positioning a detector apparatus both in the first pellet outlet and in the second pellet outlet, on the one hand an ejected pellet conveyed through the second pellet outlet, being embodied for example as a bad channel, may be directly detected. On the other hand, in the pellet flow discharged through the first pellet outlet, being embodied for example as a good channel, a gap corresponding to the ejected reject pellet may be detected, and thus indirectly the ejected pellet. Thus a reliable redundant monitoring of the pellet ejection is ensured. Faulty detection results due to blocked nozzle openings or the like are eliminated.

As detector apparatuses, for example light barriers, in particular tubular light barriers, are possible. By means of light barriers a particularly reliable and accurate identification of pellets and/or gaps in the pellet flow is possible. However, also other sensors are possible for the detector apparatuses, for example capacitive sensors.

An exemplary embodiment of the invention is explained below in greater detail based on figures. They schematically show:

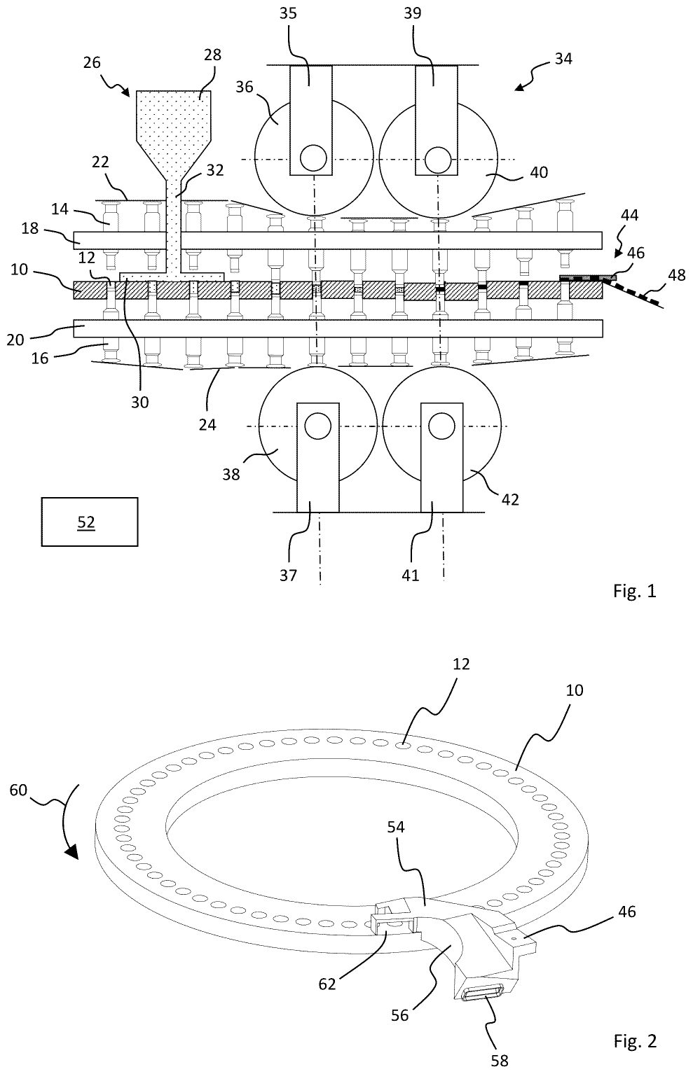

FIG. 1 a rotary press according to the invention in an unrolled representation of the rotor,

FIG. 2 a perspective view of a part of the rotary press from FIG. 1,

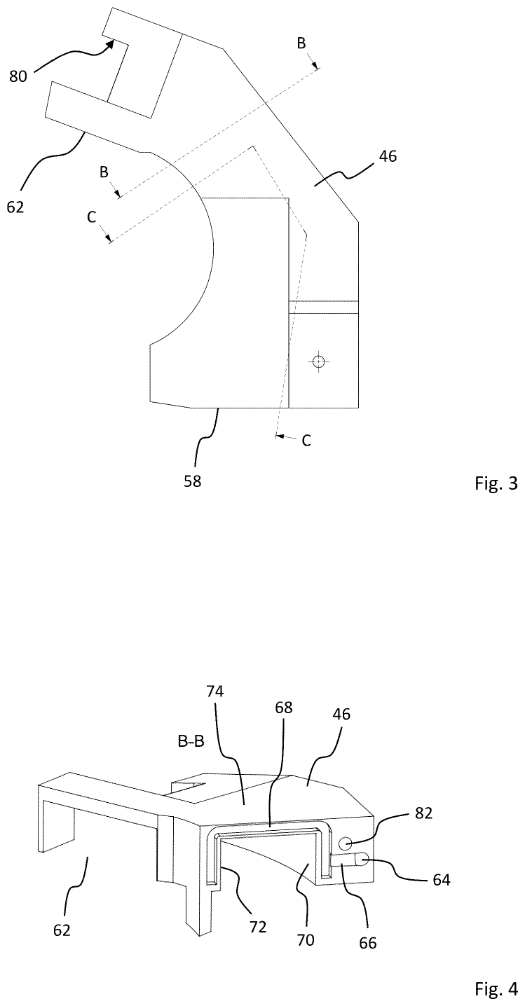

FIG. 3 a top view of the removal channel of the rotary press according to the invention,

FIG. 4 a sectional view along line B-B in FIG. 3,

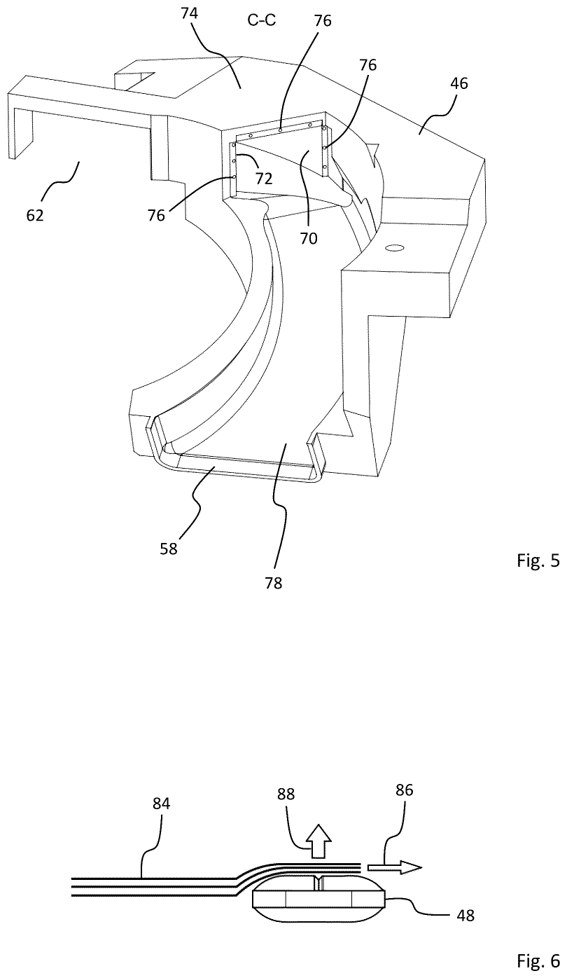

FIG. 5 a sectional view along line C-C in FIG. 3, and

FIG. 6 a representation to illustrate the flow over a tablet produced in the rotary press.

If not otherwise specified, the same reference signs denote the same subject matter in the figures.

The rotary press according to the invention shown in FIG. 1 is a rotary press for producing tablets, and in which powdered material is pressed to form tablets. The rotor of the rotary press is driven in rotation by a rotary drive and comprises a die plate 10 which has a plurality of cavities 12. The cavities 12 can be formed, for example, by bores in the die plate 10. The rotor further comprises a plurality of upper pressing punches 14 and lower pressing punches 16 which revolve synchronously with the die plate 10. The upper pressing punches 14 are axially guided in an upper punch guide 18 and the lower pressing punches 16 are axially guided in a lower punch guide 20. The axial movement of the upper pressing punches 14 and lower pressing punches 16 in the course of the rotation of the rotor is controlled by upper control cam elements 22 and lower control cam elements 24. Furthermore, a filling apparatus 26 is provided which has a filling reservoir 28 and a filling chamber 30 which are connected via a filling tube 32. In this manner, in the present example, powdered material arrives from the filling reservoir 28 via the filling tube 32 into the filling chamber 30 due to gravity and from there via a filling opening provided on the underside of the filling chamber 30 into the cavities 12 of the die plate 10, again due to gravity.

The rotary press further comprises a pressure apparatus 34. The pressure apparatus 34 comprises a pre-pressure apparatus with an upper pre-pressure roller 36 held on an upper holder 35 and a lower pre-pressure roller 38 held on a lower holder 37, as well as a main pressure apparatus with an upper pressure roller 40 held on an upper holder 39 and a lower pressure roller 42 held on a lower holder 41. In addition, the rotary press comprises a removal apparatus 44 with a removal channel 46. The removal channel removes tablets 48, which are conveyed onto the upper side of the die plate 10 by the lower pressing punches 16, from the die plate 10 and conveys the tablets 48 through the removal channel 46 to a first pellet outlet 58. The removal channel 46 can be sickle-shaped, for example, and is explained in more detail with reference to the following figures. Furthermore, the rotary press comprises a control apparatus 52 for controlling the operation of the rotary press.

In FIG. 2, only the die plate 10 with the cavities 12 and the removal channel 46 of the removal apparatus 44 of the rotary press shown in FIG. 1 are shown for illustration purposes. The removal channel 46 comprises a first portion 54 arranged above the die plate 10 and a second portion 56 arranged radially outside the die plate. The removal channel 46 leads to the first pellet outlet 58, via which tablets 48 that are identified, for example, as good can be discharged from the rotary press for further processing. During operation, the die plate 10 rotates counterclockwise, as indicated by the arrow 60 in FIG. 2. In the direction of rotation of the die plate 10 and thus in the direction of conveyance of the tablets 48 into the removal channel 46, a second pellet outlet 62 is arranged upstream of the first pellet outlet 58, by means of which tablets 48 identified as bad, for example, by sensors of the rotary press can be fed to a bad outlet for rejects.

FIGS. 3 to 5 will be used to explain the structure of the removal apparatus 44 according to the invention in more detail. In the sectional view of FIG. 4, a supply channel 64, which is connected to a pressure supply (not shown in detail) of a compressed gas supply apparatus and via which a compressed gas, in particular compressed air, is made available for vacuum nozzles of the vacuum apparatus integrated into the removal channel 46, can be seen arranged so as to be integrated into the removal channel. In the example shown, compressed air is fed as a compressed gas from the supply channel 64, which runs parallel to the path of conveyance of tablets 48 through the removal channel 46, to a U-shaped portion 68 of the removal channel 46 via a cross-connection 66. The U-shaped portion 68 is formed by a first channel wall 70, a second channel wall 72 and a channel ceiling 74. As can be seen in particular in FIG. 5, the portion 68 opens into several vacuum nozzles 76 arranged along a likewise U-shaped profile. The compressed air fed via the supply channel 64 is conducted via the U-shaped portion 68 to the vacuum nozzles 76 and blown out by them in the desired direction of movement of the tablets 48 conveyed through the removal channel 46. This creates a suction effect on the tablets 48 ejected from the cavities 12 by the lower pressing punches 16, in the present example already in the course of the ejection process, when the tablets 48 are still at least partially in the cavity 12. As can be further seen in particular in FIG. 5, the removal channel 46 has, in its portion located radially outside the die plate 10, an outlet chute portion 78 as a channel floor, via which the tablets 48 conveyed by the suction effect of the vacuum apparatus reach the first pellet outlet 58 due to gravity. FIG. 5 also shows that several vacuum nozzles 76 are arranged in each of the first channel wall 70 and the second channel wall 72 as well as in the channel ceiling 74. The vacuum nozzles 76 can each have an elongated nozzle portion, which extends in the direction of conveyance of the tablets 48 to the first pellet outlet 58 and through which the compressed gas or, respectively, compressed air is conducted. In the portion 54 arranged above the die plate 10, on the other hand, the removal channel 46 has no floor, so that the space delimited by the first and second channel walls 70, 72 and the channel ceiling 74 is formed on its underside by the die plate 10 rotating under the removal channel 46.

Also integrated into the removal channel 46 is a sorting nozzle 80, which is concealed in FIGS. 4 and 5 and schematically designated in FIG. 3 and which is part of a sorting apparatus for sorting tablets 48 which are identified as bad, for example by sensors of the rotary press, into the second pellet outlet 62. A further supply channel 82 is connected to the compressed gas supply and is also integrated into the removal channel 46 and supplies the sorting nozzle 80 with compressed gas, in particular compressed air. By briefly emitting a blast of compressed gas through the sorting nozzle 80, tablets 48 that are identified as bad can be blown out of their path of conveyance into the second pellet outlet 62 in a targeted manner. As can be seen in the figures, the removal channel 46 extends as far as the sorting apparatus, in particular the sorting nozzle 80. In particular, the sorting nozzle 80 is integrated into the removal channel 46 as explained.

As already explained, the vacuum apparatus according to the invention, in particular the vacuum nozzles 76, ensures that an extraction effect on tablets 48 is already generated during ejection from the cavities 12 by the lower pressing punches 16. In addition, the design of the vacuum apparatus, in particular the arrangement of the vacuum nozzles 76, ensures that the air flow generated by the vacuum nozzles 76 flows over the tablets 48 which have been ejected from the cavities 12 by the lower pressing punches 16 and are located on the die plate 10.

The air flow 84 over a tablet 48 is illustrated in FIG. 6. Due to the flow, two force components act on the tablet 48, namely on the one hand in the desired direction of movement of the tablet 48, as illustrated by the arrow 86, and on the other hand vertically upward, as illustrated by the arrow 88. In this way, it is ensured that the tablets 48 are conveyed particularly reliably.

### List of Reference Signs

10 Die plate
12 Cavities
14 Upper pressing punches
16 Lower pressing punches
18 Upper punch guide
20 Lower punch guide
22 Upper control cam elements
24 Lower control cam elements
26 Filling apparatus
28 Filling reservoir
30 Filling chamber
32 Filling tube
34 Pressure apparatus
35, 39 Upper holders
37, 41 Lower holders
36 Upper pre-pressure roller
38 Lower pre-pressure roller
40 Upper pressure roller
42 Lower pressure roller
44 Removal apparatus
46 Removal channel
48 Tablets, pellets
52 Control apparatus
54 First portion
56 Second portion
60 Arrow
62 Second pellet outlet
64 Supply channel
66 Cross-connection
68 Portion
70 First channel wall
72 Second channel wall
74 Channel ceiling
76 Vacuum nozzles
78 Outlet chute portion
80 Sorting nozzle
82 Supply channel
84 Air flow
86 Arrow
88 Arrow

1. A rotary press comprising a rotor rotatable by means of a rotary drive, wherein the rotor has an upper punch guide for upper pressing punches and a lower punch guide for lower pressing punches as well as a die plate arranged between the punch guides, wherein the pressing punches interact with cavities of the die plate, wherein the rotary press further comprises a filling apparatus, by means of which powder material to be pressed is filled into the cavities of the die plate, and wherein the rotary press comprises a pressure apparatus with an upper pressure unit and a lower pressure unit which, during operation, interact with the upper pressing punches and with the lower pressing punches (16) to press the powder material in the cavities of the die plate to form pellets, and wherein the rotary press comprises a removal apparatus for removing pellets ejected onto the upper side of the die plate by the lower pressing punches after pressing, wherein the removal apparatus has a removal channel arranged at least in portions above the die plate, so that pellets ejected from the cavities onto the upper side of the die plate by the lower pressing punches are conducted along the removal channel from the die plate to a first pellet outlet, wherein the portion of the removal channel arranged above the die plate has a vacuum apparatus, by means of which the pellets located on the die plate are sucked along the removal channel to the first pellet outlet.

2. The rotary press according to claim 1, wherein the vacuum apparatus is arranged on the portion of the removal channel arranged above the die plate in such a way that an extraction effect is generated by the vacuum apparatus on pellets already during ejection from the cavities by the lower pressing punches.

3. The rotary press according to claim 1, wherein the vacuum apparatus is arranged on the portion of the removal channel arranged above the die plate in such a way that an air flow generated by the vacuum apparatus flows over pellets ejected from the cavities by the lower pressing punches.

4. The rotary press according to claim 1, wherein the vacuum apparatus has vacuum nozzles integrated into the portion of the removal channel arranged above the die plate.

5. The rotary press according to claim 4, wherein vacuum nozzles integrated into the portion of the removal channel arranged above the die plate are arranged above and/or close to the ejection point of the pellets when they are ejected from the cavities by the lower pressing punches.

6. The rotary press according to claim 4, wherein the removal channel has a first channel wall guiding the pellets to the first pellet outlet and a channel ceiling covering the removal channel at least in portions, and in that vacuum nozzles are arranged in the first channel wall and in the channel ceiling.

7. The rotary press according to claim 6, wherein the removal channel also has a second channel wall opposite the first channel wall, and in that vacuum nozzles are also arranged in the second channel wall.

8. The rotary press according to claim 7, wherein the first channel wall, the channel ceiling and the second channel wall form a U-profile.

9. The rotary press according to claim 4, wherein the vacuum nozzles each have an elongated nozzle portion extending in the direction of conveyance of the pellets toward the first pellet outlet, and in that a compressed gas, is conducted through the elongated nozzle portion by the vacuum apparatus.

10. The rotary press according to claim 4, wherein the vacuum apparatus has a compressed gas supply apparatus, for supplying the vacuum nozzles with compressed gas, wherein the compressed gas supply apparatus has a supply channel leading along the removal channel from a compressed gas supply to the vacuum nozzles.

11. The rotary press according to claim 10, wherein the supply channel is integrated into the removal channel.

12. The rotary press according to claim 1, wherein a sorting apparatus is also provided for sorting pellets ejected from the cavities into a second pellet outlet arranged upstream of the first pellet outlet in the direction of conveyance of the pellets, wherein the sorting apparatus comprises a sorting nozzle for sorting pellets into the second pellet outlet by means of compressed gas.

13. The rotary press according to claim 12, wherein the sorting nozzle is also supplied with compressed gas by the compressed gas supply.

14. The rotary press according to claim 12, wherein the removal channel extends as far as the sorting apparatus.

15. The rotary press according to claim 12, wherein the sorting nozzle is integrated into the removal channel.

16. The rotary press of claim 1, wherein a first detector apparatus is arranged in the first pellet outlet, said first detector apparatus detecting pellets conducted through the first pellet outlet and/or that a second detector apparatus is arranged in a second pellet outlet, said second detector apparatus detecting pellets conducted through the second pellet outlet.

17. The rotary press according to claim 9, wherein the compressed gas comprises compressed air.

18. The rotary press according to claim 10, wherein the compressed gas supply apparatus comprises a compressed air supply apparatus for supplying the vacuum nozzles with compressed air.
